(19) United States
(12) Patent Application Publication
(10) Pub. No.: US 2003/0036930 A1
(43) Pub. Date: Feb. 20, 2003

(54) Method and system for creating travel packages

(75) Inventors: Tomas A.D. Matos, Sammamish, WA (US); Steve Murch, Seattle, WA (US); Maja Bogdanovic, Seattle, WA (US); Eric Monsowitz, Seattle, WA (US); Lloyd Frink, Seattle, WA (US); Christopher Roberts, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Expedia, Inc.

(21) Appl. No.: 09/932,268

(22) Filed: Aug. 17, 2001

(51) Int. Cl. G06F 17/60

(52) U.S. Cl. 705/5

(57) ABSTRACT

The present invention relates in general to on-line transportation reservation processing and, in particular, to a system and method for identifying and purchasing travel packages on-line.

In one embodiment, package components are retrieved by a package server in response to a query from a consumer. A best package component is identified from the retrieved package components. Then a listing of packages matching the best package component is depicted for the consumer with real-time prices to the consumer.

In another embodiment of the present invention, real-time prices corresponding to travel packages are related to published fares for package components. The relationship is calculated to maximize the real-time price relative to the price for published fares for the travel components.

In still another embodiment of the present invention, travel packages are cross-sold to consumers when they are seeking to purchase a travel component that may be included in a travel package.

### FIELD OF THE INVENTION

The present invention relates in general to on-line transportation reservation processing and, in particular, to a system and method for identifying and purchasing travel packages on-line.

### BACKGROUND OF THE INVENTION

Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”) consisting of a few computers or workstations and related devices; to a wide area network (“WAN”) which interconnects computers and LANs that are geographically dispersed; to a remote access service (“RAS”) which interconnects remote computers via temporary communication links. An internetwork, in turn, is the joining of multiple computer networks, both similar and dissimilar, by means of gateways or routers that facilitate data transfer and conversion from various networks. A well-known abbreviation for the term internetwork is “internet.” As currently understood, the capitalized term “Internet” refers to the collection of networks and routers that use the Internet Protocol (“IP”) along with higher level protocols such as the Transmission Control Protocol/Internet Protocol (“TCP/IP”) or the Uniform Datagram Packet/Internet Protocol (“UDP/IP”) to communicate with one another.

The Internet has recently seen explosive growth by virtue of its ability to link computers located throughout the world. As the Internet has grown, so has the World Wide Web (“WWW” or “Web”). The Web is a vast collection of interconnected or “hypertext” documents in HyperText Markup Language (“HTML”) that are electronically served at “Web sites” throughout the Internet. It is also one of the best known examples of a interactive hypertext environment. Other interactive hypertext environments may include proprietary environments such as those provided in America On-line or other on-line service providers, as well as the “wireless Web” provided by various wireless networking providers, especially those in the cellular phone industry. It will be appreciated that the present invention could apply in any such interactive hypertext environments, however, for purposes of discussion, the Web is used as an exemplary interactive hypertext environment with regard to the present invention. The Web has quickly become a popular method of disseminating information due in large part to its simplicity and its ability to deliver information in a variety of formats. To make information available over the Web, a user typically composes a set of “Web pages” which are posted on a Web site by an Internet Service Provider (“ISP”). A Web site resides on a server connected to the Internet that has mass storage facilities for storing hypertext documents, a.k.a. “Web pages,” and that runs administrative software for handling requests for those stored hypertext documents. A hypertext document normally includes a number of hyperlinks, i.e., highlighted portions of text which link the document to another hypertext document possibly stored at a Web site elsewhere on the Internet. Each hyperlink is associated with a Uniform Resource Locator (“URL”) that provides the exact location of the linked document on a server connected to the Internet and describes the document. Thus, whenever a document or file is retrieved from any Web server, the document or file is considered to be retrieved from the Web.

A user is allowed to retrieve hypertext documents from the Web, i.e., a user is allowed to “surf the Web,” via a Web browser. A Web browser, such as NETSCAPE NAVIGATOR®, MICROSOFT® Internet Explorer or phone.com's UP.link microbrowser, is a software program implemented by a Web client, i.e., the user's computer, cell phone or other consumer device, to provide a graphical user interface (“GUI”) to the Web. Upon request from the user via the Web browser, the Web client accesses and retrieves the desired hypertext document from the appropriate Web server using the URL for the document and a protocol known as HyperText Transfer Protocol (“HTTP”). HTTP is a higher-level protocol than TCP/IP and is designed specifically for the requirements of the Web. It is used on top of TCP/IP to transfer hypertext documents between servers and clients.

At the advent of the Web, the information stored on the Internet was generally static in nature and if one wanted to change the information provided on a Web site it was necessary to manually configure the Web site by rewriting its HTML code. However, at the present stage of development on the Web, many Web sites provide dynamic content that changes depending on a user's interaction between the Web browser on the user's consumer device and the Web site. These dynamic hypertext documents are well known in the art and may be produced in a myriad of different manners, such as by using Common Gateway Interface (“CGI”) scripts processed by a Web server or local scripts just as JAVAScript processed by a Web browser.

The present invention relates to network-based, and Internet-based travel services, such as a travel service offering tickets for transportation, including airline tickets, train tickets, bus tickets, ferry tickets, etc. to customers over the Internet. With such a service, a customer, using a computer connected to the travel service via the Internet, can purchase items from a dynamically changing inventory including airline tickets, train tickets, bus tickets, ferry tickets, lodgings, etc., for rentals, attractions and combinations thereof. Typically, such a travel service cooperates with a centralized computer reservation system (“CRS”). A CRS is a system/service that communicates with travel agents or transportation services for the purpose of providing up-to-date fare (price for a trip or combination of routes comprising a trip), schedule (date and time of arrival and departure of a trip or flight), rules (which fares are valid under which circumstances) and availability (capacity for a particular trip or flight to provide accommodation at a particular fare) in response to a query. This information is provided to the CRS by the transportation carriers, typically through third parties; however, a travel service can also cooperate with other databases, such as a local database reflecting specific relationships between carriers and the travel service, such as discount contracts or incentive programs. Accordingly, an Internet-based service can have access to many sources of carrier inventory and prices. The CRS, may also be used to reserve and/or book travel components in travel packages, i.e., groupings of air, flight, hotel, and or other travel services/products.

The business environment of a travel service is such that there are numerous ways of providing the same or a similar end product to the consumer at a variety of prices. Due to carrier-driven preferences, it may be cost effective to price similar inventory differently. For example, in the case of airline reservations, the number of ways that a consumer can travel from point A to point B is great when the number of airline carriers, different travel paths, hub locations and other particulars are considered. For this reason, the price of a particular generic segment from point A to point B may vary considerably across time, airline carriers, and the like. Further, compounding price variations are price sensitivities, which can reflect, e.g., an increase in demand for tickets reserved proximate to departure time. Additionally, incentive and discount programs negotiated with individual carriers can further affect the price offered by a travel service. Also, certain classes of inventory may have associated high or low demands, or high or low volume sales. Still further, flights included in a travel package may be eligible for further discounts over a fare not in a package.

In addition, there are numerous consumer driven preferences which can affect pricing as well. Some consumers will value individual characteristics of a given item of inventory differently. For example, in the case of airline tickets, a consumer may not value when the flight (flying from one place to the next) takes place, whereas another consumer may value a particular carrier over all others. These preferences can be factored into flights offered when the consumer specifies their preferences. While in a hotel setting some consumer may prefer a particular hotel company, while others may only consider the location of the hotel. For these reasons and others, there are numerous factors that can affect the value of the same or similar end product.

Furthermore, in a conventional Internet-based travel service, a consumer enters very specific information concerning desired supplier inventory, and the Internet-based travel service queries remote servers for inventory that matches that specific query. The remote servers perform searches of their databases to find matches for the query and return results to the Internet-based travel service for viewing by the consumer. However, a traditional remote server search in response to a query is limited.

One limitation results from the fact that previous attempts to create travel packages on-line have not provided real-time pricing and availability to consumers. This limitation leads to unrealistic expectations. For example, if a consumer sees a Web page with package pricing in “ranges,” such as, a flight to Las Vegas from Seattle with car and hotel for a weekend priced at “$300 and up,” then they expect that at least one package will have a price of $300.00. However, once actually booked through such a previous system, the lowest price might end up being considerably higher (e.g., not $300, but $1,300). Unfortunately, which the consumer would only discover this price of $300.00 at the end of the booking process.

Further exacerbating the frustration caused by previous attempts of providing on-line packages, were the numerous steps involved in identifying, reserving, and booking packages. Usually an inordinate number of steps or Web pages had to be navigated to finally reach an actual price and be able to book an actual package, and if the consumer were unfortunate enough to want to modify elements of the package, they would have to re-navigate many or all of the previous pages that had already been navigated to purchase the package. This would be particularly frustrating when after all the navigation, it would turn out that there was no availability for the dates, times, or travel components specified by the consumer.

A recent issue for travel service providers is that hotels and other providers of package components such as airlines and car rental companies have cut back the commissions formerly paid to travel agents and, in particular, have cut back to providers of on-line booking of travel components and/or packages. However, these carriers and lodging companies are still willing to provide significant discounts to consumers for the actual travel or lodging. Accordingly, there is a need for travel service providers to maintain a good level of service and selection by maximizing their profit on the sale of travel services to the consumer while still providing the consumer with cost effective travel solutions.

Another failure on the part of previous attempts at providing on-line package services has been the inability to cross-sell the packages to consumers seeking individual package components. In particular, previous attempts have failed to provide real-time pricing and availability options to consumers seeking to buy a number of package components individually. Therefore, there is a need for providing cross-selling information to consumers in a real-time manner to allow them to compare purchasing components individually or in a package.

A still further drawback of previous solutions to providing on-line packages has been the inability to provide real-time availability and pricing comparisons between disparate packages. As each individual package required numerous Web pages to create and only near the end of the process was a price provided, it was inconvenient and inefficient to follow this series of Web pages for numerous packages for comparison purposes. Therefore, there is a need for effective availability and pricing comparison capability in an on-line package system.

Additionally, previous package systems have comprised conventional package components such as car rentals, lodging, and transportation. Cruises of course could be considered as “lodging.” However, it is desirable to also include other components for a package in an efficient manner. Accordingly, an efficient on-line package system would include the ability to add services and attractions other than conventional travel components to a package.

Another drawback to previous travel services that did provide access to services and/or attractions either in or outside of packages was that vouchers or tickets for the packages had to be mailed directly to the consumer. These mailings could be damaged, lost, or delayed in transit to the consumer. Accordingly, even though the consumer may have paid for the services or attractions, they may be unable to use the vouchers they paid for. Therefore, there is a need for a faster and more reliable method of delivering vouchers to the consumer that is both easy for the consumer and cost effective for the travel services. As will be described in more detail below, the present invention solves these problems and provides other significant distinctions and advantages over the prior art.

### SUMMARY OF THE INVENTION

The limitations of prior systems are overcome by the present invention, which is a method and system for identifying, reserving, and booking travel packages on-line. In one embodiment, package components are retrieved by a package server in response to a query from a consumer. A best package component (such as a particular flight, train, hotel, or even ferry) is identified from the retrieved package components. Then a listing of packages matching the best package component is depicted for the consumer with real-time prices (and accordingly, availability) to the consumer. In one actual embodiment of the present invention, only two hypertext pages are needed to depict the plurality of packages to the consumer. In such an embodiment, it would then also be possible to identify, reserve, and book such a package in six or fewer hypertext pages.

In another embodiment of the present invention, real-time prices corresponding to travel packages are related to published fares for package components. The relationship is calculated to maximize the real-time price relative to the price for published fares for the travel components. In one embodiment, the real-time price is calculated by increasing a discount price to correspond to a predetermined percentage of the combined, published fares of the travel components. In still another embodiment of the present invention, add-ons are identified that match each individual package and the original query from the consumer. The consumer may then select any desired add-ons to be added to their desired package. Additionally, should vouchers be used with the selected add-ons, these vouchers may be delivered via an interactive hypertext environment. The vouchers may include tamper resistant elements, including but not limited to, a registered serial number for each voucher, a security code corresponding to the type of voucher, and an authorized user, as well as being formatted in a graphical image delivered via an interactive hypertext environment.

In still another embodiment of the present invention, travel packages are cross-sold (e.g., offered to consumer when a similar item is searched for) to consumers when they are seeking to purchase a travel component(s) that may be included in a travel package. For example, a consumer seeking a flight might be presented with real-time prices for packages matching the query used to identify a flight. These packages may include lodging, airfare, car rentals, add-ons, etc., or any combination thereof.

Still further embodiments of the present invention allow for internal package relevance. In other words, when identifying components for a travel package where vehicle, lodging and/or flight components are retrieved in response to a package query, the level of service provided in one component is reflected in other components. For example, if a first class flight is used as the basis of building a travel package, then higher class hotels and more luxurious cars would automatically be included as preferred options in a travel package. Similarly, if a default or economy flight were used but a higher class hotel, such as a four or five star hotel was presented, then the car associated with the package would also be of a luxury model.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 (Prior Art) is an illustration of a representative portion of an internetwork such as the Internet.

FIG. 2 is a pictorial diagram of a number of devices connected to an internetwork which provide a client device with travel packages in response to a package query in accordance with the present invention.

FIG. 3 is a block diagram illustrating several components of the client device shown in FIG. 2 used to request travel packages in accordance with the present invention.

FIG. 4 is a block diagram illustrating several of the components of a Web server shown in FIG. 2 used to communicate with the client device and produce vouchers in accordance with the present invention.

FIG. 5 is a block diagram illustrating several of the components of a travel server shown in FIG. 2 used to identify, reserve and book travel packages in response to a travel query in accordance with the present invention.

FIGS. 6A-C are diagrams illustrating the actions taken by a client device, Web server, travel server, lodging, car and add-on servers and a computer reservation system to identify, reserve and book travel packages in response to a package query in accordance with the present invention.

FIG. 7 is an overview flow diagram illustrating a package service routine implemented by the travel server to identify, reserve and book travel packages in accordance with the present invention.

FIG. 8 is an overview flow diagram illustrating a package search subroutine implemented by the travel server.

FIG. 9 is an overview flow diagram illustrating a package creation subroutine implemented by the travel server.

FIG. 10 is an overview flow diagram illustrating a package booking subroutine implemented by the travel server.

FIG. 11 shows an overview flow diagram illustrating a voucher creation routine implemented by the Web server in accordance with the present invention.

FIGS. 12-14 show exemplary Web pages for identifying and selecting travel packages in accordance with the present invention.

### DETAILED DESCRIPTION OF THE PREFERRED EMBODIMENT

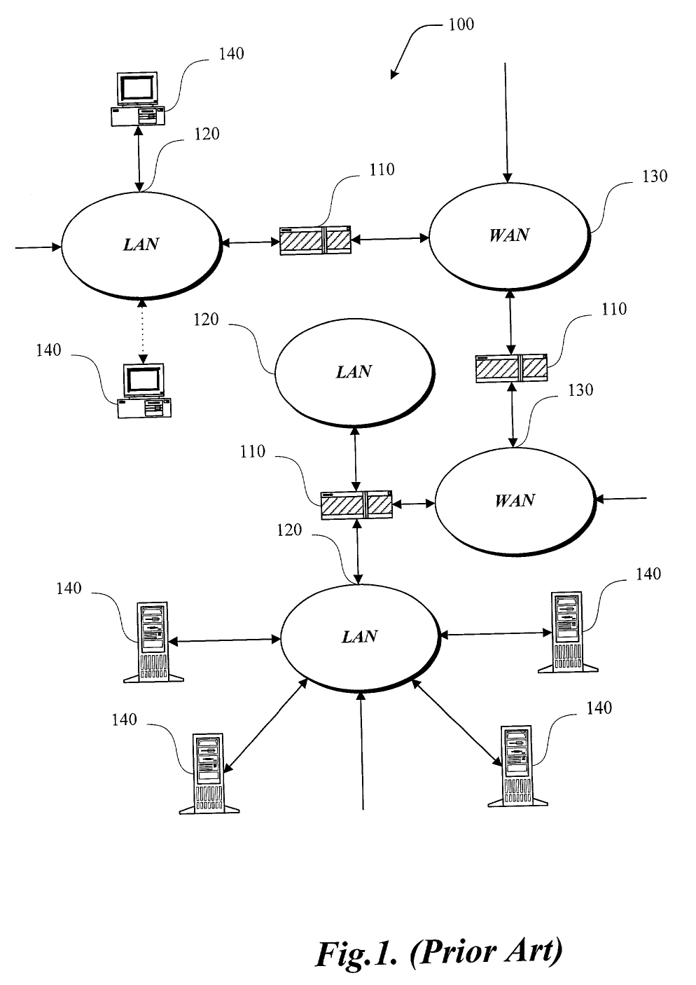

As previously explained, the capitalized term “Internet” refers to the collection of networks and routers that use the Internet Protocol (“IP”) to communicate with one another. A representative section of the Internet 100 is shown in FIG. 1 (Prior Art) in which a plurality of LANs 120 and WANs 130 are interconnected by routers 110. The routers 110 are generally special purpose computers used to interface one LAN or WAN to another. Communication links within the LANs may be twisted pair wire, or coaxial cable, while communication links between networks may utilize 56 Kbps analog telephone lines, or 1 Mbps digital T-1 lines and/or 45 Mbps T-3 lines. Further computers and other related electronic devices can be remotely connected to either the LANs 120 or the WAN 130 via a modem and temporary telephone link. Such computers and electronic devices 140 are shown in FIG. 1 as connected to one of the LANs 120 via dotted lines. It will be appreciated that the Internet comprises a vast number of such interconnected networks, computers and routers and that only a small, representative section of the Internet 100 is shown in FIG. 1.

The Web, on the other hand, is a vast collection of interconnected, electronically-stored information or “content” located on servers connected throughout the Internet 100. Many companies are now providing services and access to their content over the Internet 100 using the Web. For example, a number of companies provide travel services via the Internet 100 that enable customers to make reservations on-line for transportation and lodging. In accordance with the present invention, an optimized system and method are provided that determine the best available travel packages in response to a package query made by a user who is considering making a reservation and purchasing tickets for transportation, lodging, entertainment, etc. on-line. While air carriers and flights are used herein as illustrative examples of transportation for purposes of discussion of the present invention, it would be appreciated by those of ordinary skill in the art that the present invention applies equally as well to other forms of transportation as well, such as rail, road, water or any other form of transportation amenable to reservations inquiry. Furthermore, the present invention could be applied to pricing products which combine travel with related products such as hotel stays or car rentals; as selecting low price products from a large number of possible combinations is important in this market. Still, further, the present invention could be applied to non-passenger travel as well, inasmuch as package routing and delivery might benefit from travel package searching to increase efficient delivery of packages for the least cost.

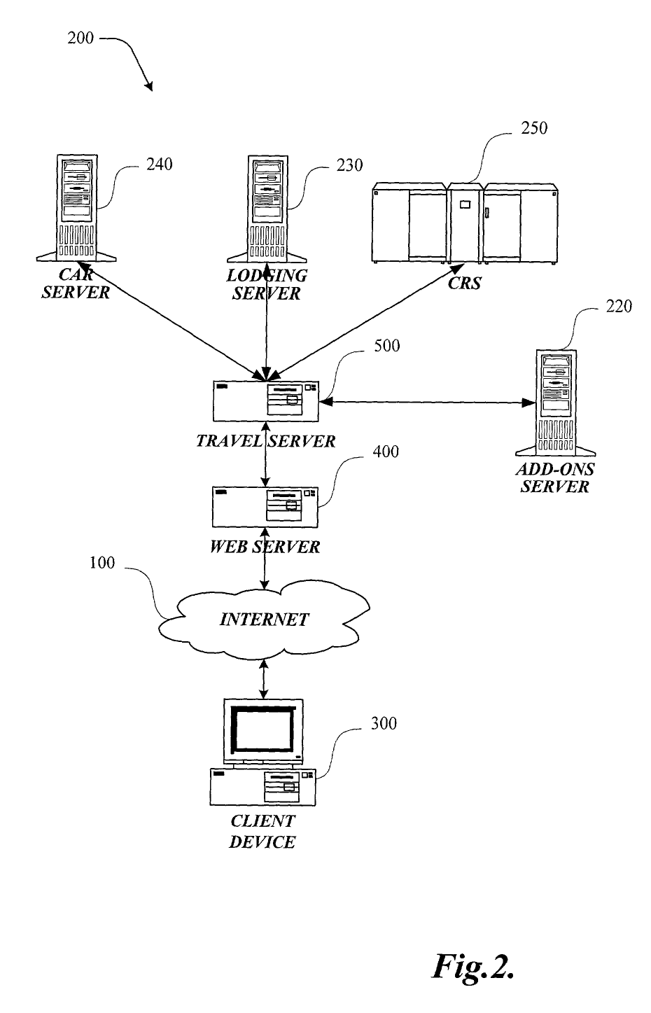

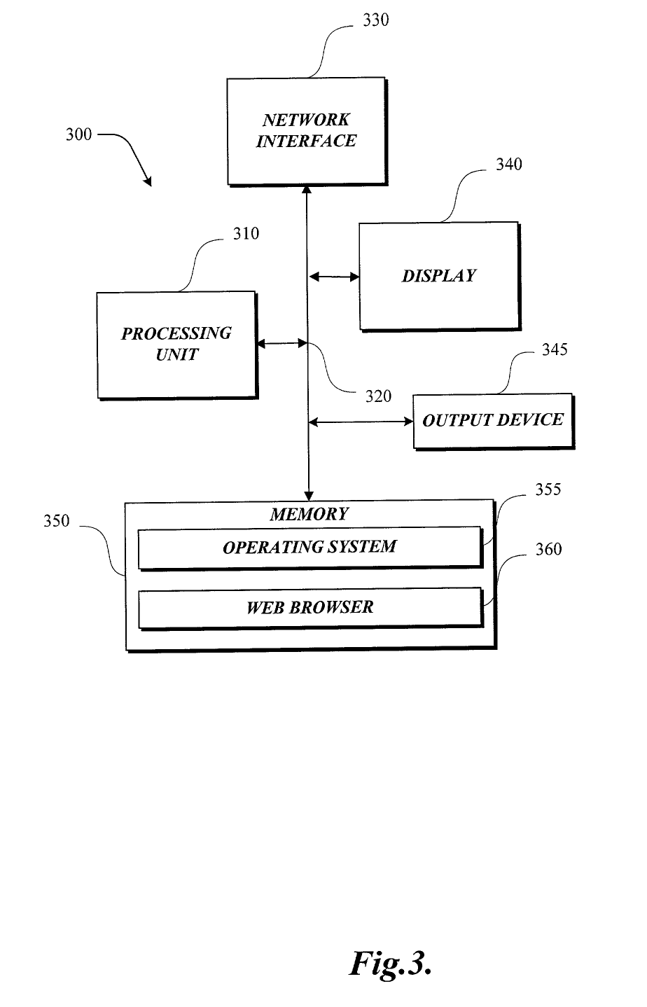

FIG. 2 illustrates a functional block diagram of a system 200 for determining a list of travel packages in response to a query made by a user of the consumer device 210. The system 200 generally operates in a distributed computing environment comprising individual computer systems interconnected over a network (such as the Internet 100). However, it will be appreciated by those of ordinary skill in the art that the system 200 could equally function as a single, stand-alone computer system. In the described embodiment, a client device 300, a Web server 400, and a travel server 500 are interconnected over an internetwork, such as the Internet 100, or perhaps over an intranetwork. The client device 300, the Web server 400 and the travel server 500 are further described below in relation to FIGS. 3, 4, and 5, respectively. The system 200 also comprises one or more connections to a CRS 250, which as noted above, is a system/service for providing up-to-date fare, schedule and availability information for transportation services. Additionally, the system 200 comprises a car server 240, a lodging server 230, and an add-ons server 220 which are used when searching reserving, and purchasing travel packages in accordance with the present invention. Those of ordinary skill in the art will appreciate that more or less devices may be used in the exemplary system 200. For example, the functionality of car server 240, lodging server 230, and add-ons server 220 may reside on the travel server 500. In still another embodiment, multiple Web servers 400, and/or travel servers 500 may be used in the system 200. Additionally, while only one client device has been shown, it will be appreciated that many client devices may be used in system 200.

FIG. 3 depicts several of the key components of the client device 300. Those of ordinary skill in the art will appreciate that the client device 300 may include many more components than those shown in FIG. 3. However, it is not necessary that all of these generally conventional components be shown in order to disclose an enabling embodiment for practicing the present invention. As shown in FIG. 3, the client device 300 includes a network interface 330 for connecting to the Internet 100. Those of ordinary skill in the art will appreciate that the network interface 330 includes the necessary circuitry for such a connection, and is also constructed for use with the TCP/IP protocol or other protocols such as the Internet Inter-ORB Protocol (“IIOP”).

The client device 300 also includes a processing unit 310, a display 340, an output device 345 and a memory 350 all interconnected along with the network interface 330 via a bus 320. The output device 345 could be any type of device capable of receiving output from the client device 300, such as, but not limited to, a printer, a smart card reader, a plotter or a storage mechanism like a floppy, tape or DVD/CD-ROM drive. The memory 350 generally comprises a random access memory (“RAM”), a read-only memory (“ROM”) and a permanent mass storage device, such as a disk drive. The memory 350 stores a Web browser 360 and an operating system 355. It will be appreciated that these software components may be loaded from a computer-readable medium into memory 350 of the client device 300 using a drive mechanism (not shown) associated with the computer-readable medium, such as a floppy, tape or DVD/CD-ROM drive or via the network interface 330.

Although an exemplary client device 300 has been described that generally conforms to a conventional general purpose computing device, those of ordinary skill in the art will appreciate that a client device 300 may be any of a great number of devices capable of communicating with the Internet 100 or with the Web server 400.

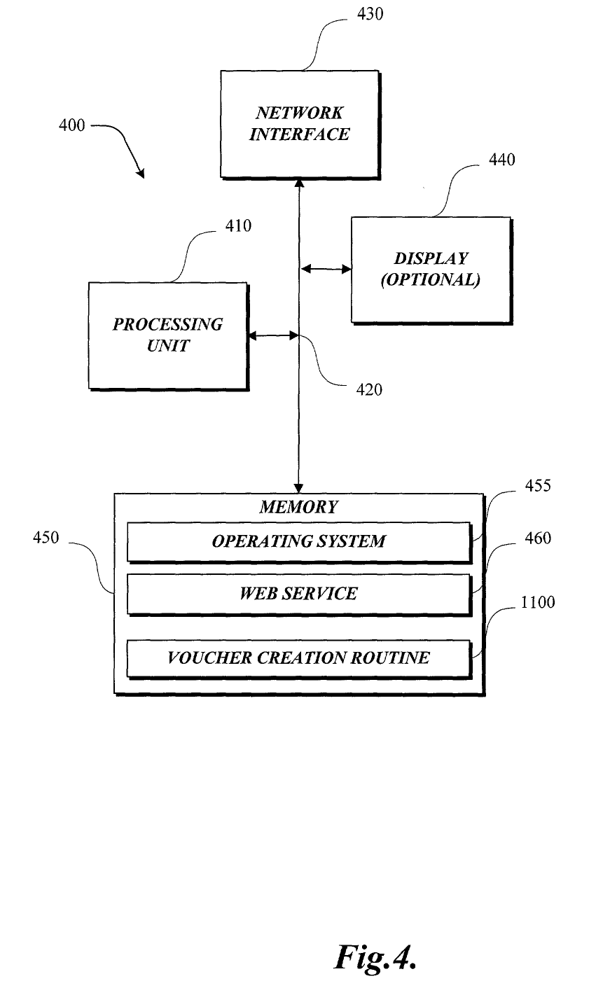

FIG. 4 depicts several of the key components of the Web server 400. Those of ordinary skill in the art will appreciate that the Web server 400 includes many more components then those shown in FIG. 4. However, it is not necessary that all of these generally conventional components be shown in order to disclose an enabling embodiment for practicing the present invention. As shown in FIG. 4, the Web server 400 is connected to the Internet 100 via a network interface 430. Those of ordinary skill in the art will appreciate that the network interface 430 includes the necessary circuitry for connecting the Web server 400 to the Internet 100, and is also constructed for use with the TCP/IP protocol or other protocols, such as the IIOP, the particular network configuration of the operating environment in which it is contained and a particular type of coupling medium.

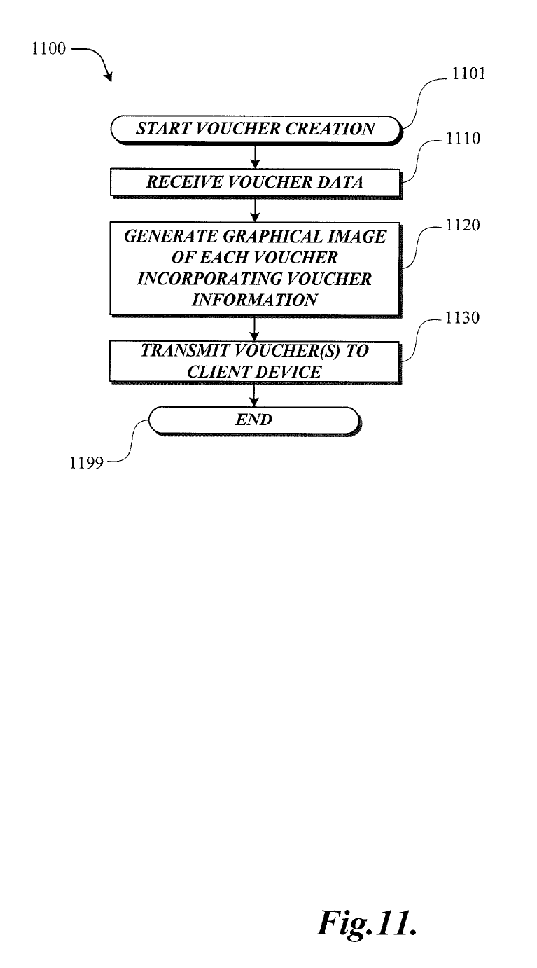

The Web server 400 also includes a processing unit 410, an optional display 440, and a mass memory 450 all interconnected along with the network interface 430 via a bus 420. The memory 450 generally comprises RAM, ROM, and one or more permanent mass storage devices, such as a hard disk drive, tape drive, optical drive, floppy disk drive, or combination thereof. The mass memory 450 stores the program code and data necessary for receiving, processing, formatting and sending messages, as well as, supplying the results of that processing in accordance with the present invention. More specifically, the memory 450 stores a Web service 460 for providing Web connectivity to the Web for computers with Web browsers, such as the client device 300 having Web browser 360. Additionally, the memory 450 stores a routine 1100 for creating vouchers for add-on services/products purchased by a consumer. The add-ons may be any type of services or attractions that could be added to a travel package, such as, but not limited to: sporting events, ferry or shuttle service, concerts, scuba diving, golf equipment rental, casino chips or meals at a restaurant. The voucher creation routine 1100 is described in greater detail below, with regard to FIG. 11.

It will be appreciated that the aforementioned software components may be loaded from a computer-readable medium into mass memory 450 of the Web server 400 using a drive mechanism (not shown) associated with the computer-readable medium, such as floppy, tape or DVD/CD-ROM drive or via the network interface 430.

Although an exemplary Web server 400 has been described that generally conforms to a conventional general purpose computing device, those of ordinary skill in the art will appreciate that a Web server 400 may be any of a great number of devices capable of communicating via the Internet 100, or providing Web pages network.

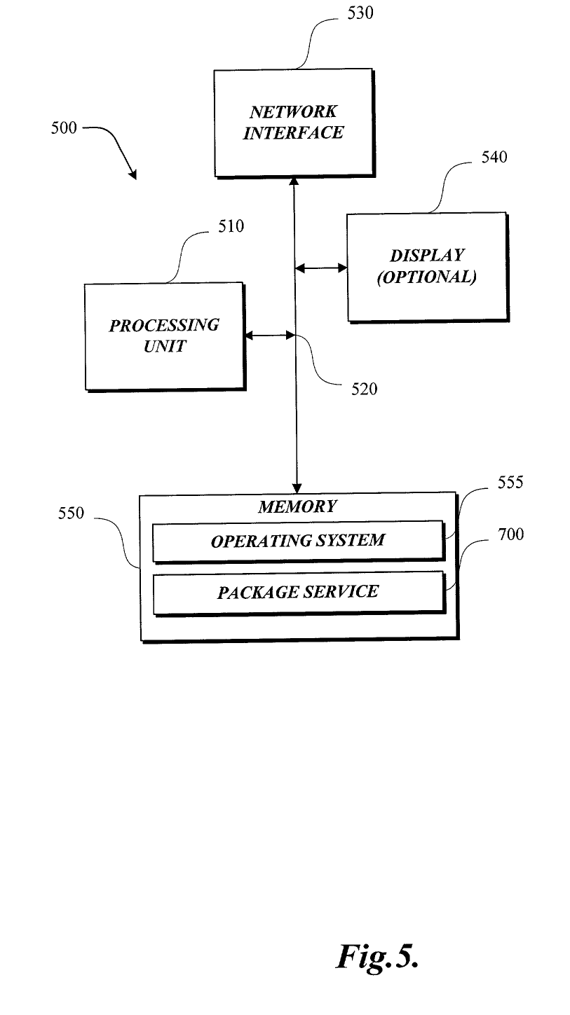

FIG. 5 depicts several of the key components of the travel server 500. Those of ordinary skill in the art will appreciate that the travel server 500 includes many more components then those shown in FIG. 5. However, it is not necessary that all of these generally conventional components be shown in order to disclose an enabling embodiment for practicing the present invention. As shown in FIG. 5, the travel server 500 is connected to the Internet 100 via a network interface 530. Those of ordinary skill in the art will appreciate that the network interface 530 includes the necessary circuitry for connecting the travel server 500 to the Internet 100, and is also constructed for use with the TCP/IP protocol or the next generation protocols, such as the IIOP, the particular network configuration of the operating environment in which it is contained and a particular type of coupling medium.

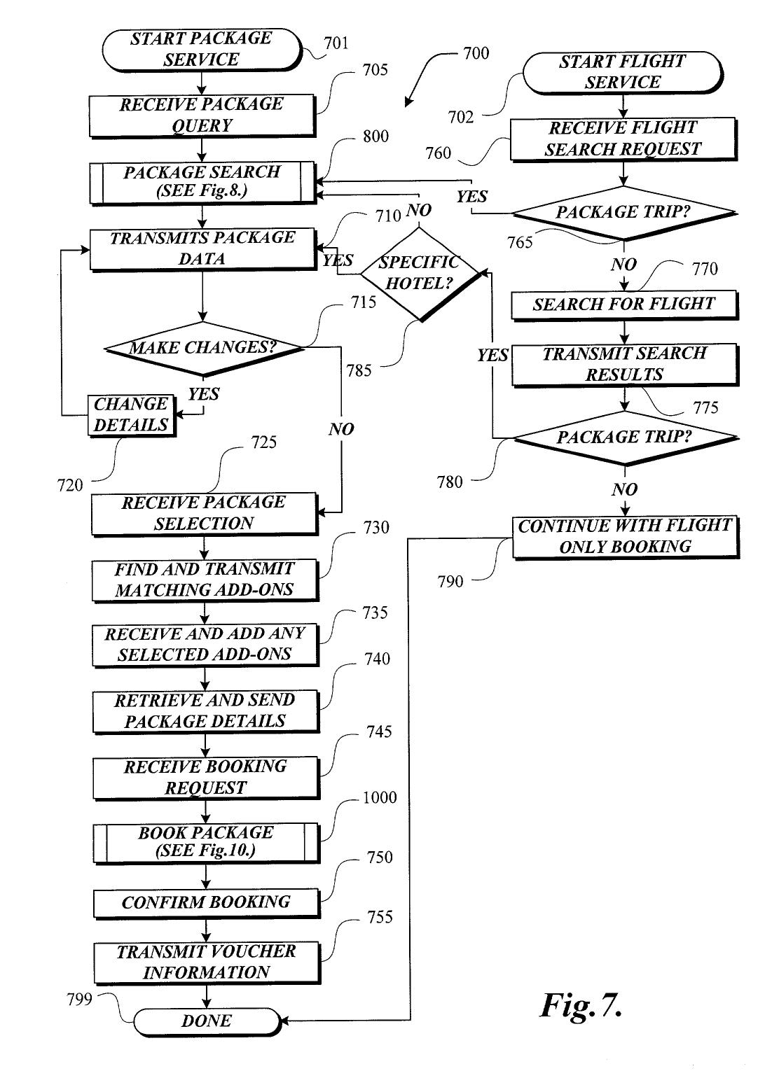

The travel server 500 also includes a processing unit 510, an optional display 540, and a mass memory 550 all interconnected along with the network interface 530 via a bus 520. The memory 550 generally comprises RAM, ROM, and one or more permanent mass storage devices, such as a hard disk drive, tape drive, optical drive, floppy disk drive, or combination thereof. The mass memory 550 stores the program code and data necessary for receiving, processing, formatting and sending messages, as well as, supplying the results of that processing in accordance with the present invention. More specifically, the memory 550 stores a package service 700, as shown and described in further detail in FIG. 7 below. Briefly, the package service 700 allows a consumer to request a list of packages which will be returned with real-time pricing according to the user's specifications. It will be appreciated that the aforementioned software components may be loaded from a computer-readable medium into mass memory 550 of the travel server 500 using a drive mechanism (not shown) associated with the computer-readable medium, such as floppy, tape or DVD/CD-ROM drive or via the network interface 430.

Although an exemplary travel server 500 has been described that generally conforms to a single conventional general purpose computing device, those of ordinary skill in the art will appreciate that a travel server 500 may be a combination of computing devices or components, coordinated to communicate with the Web server 400 over a network.

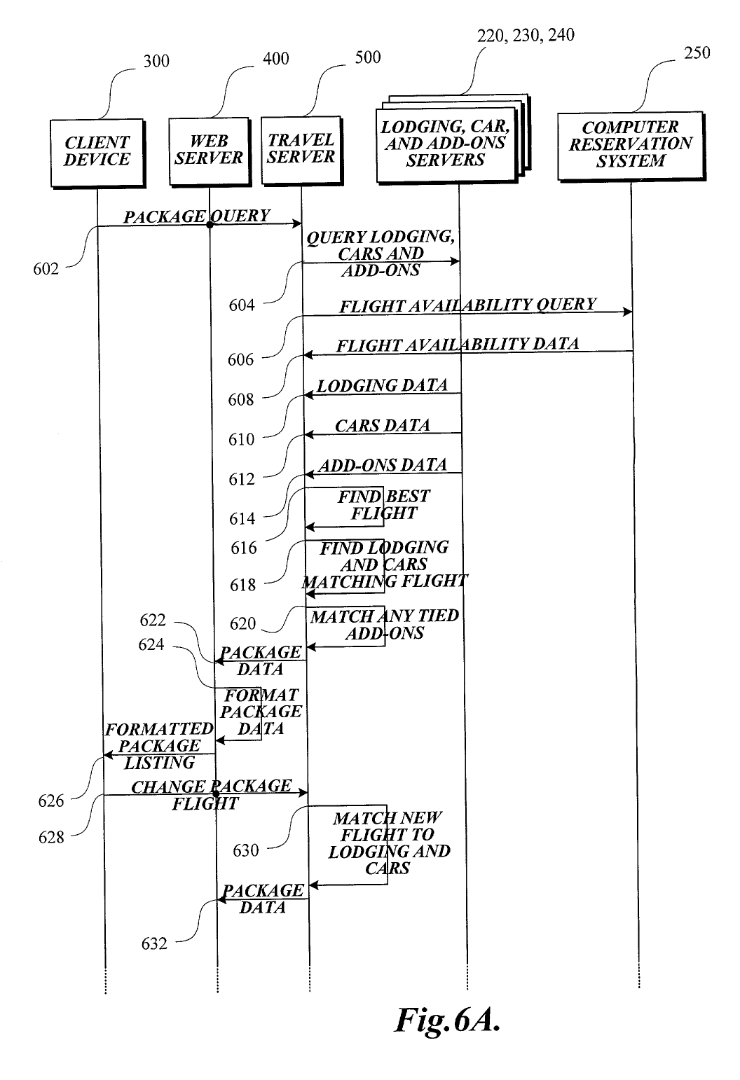

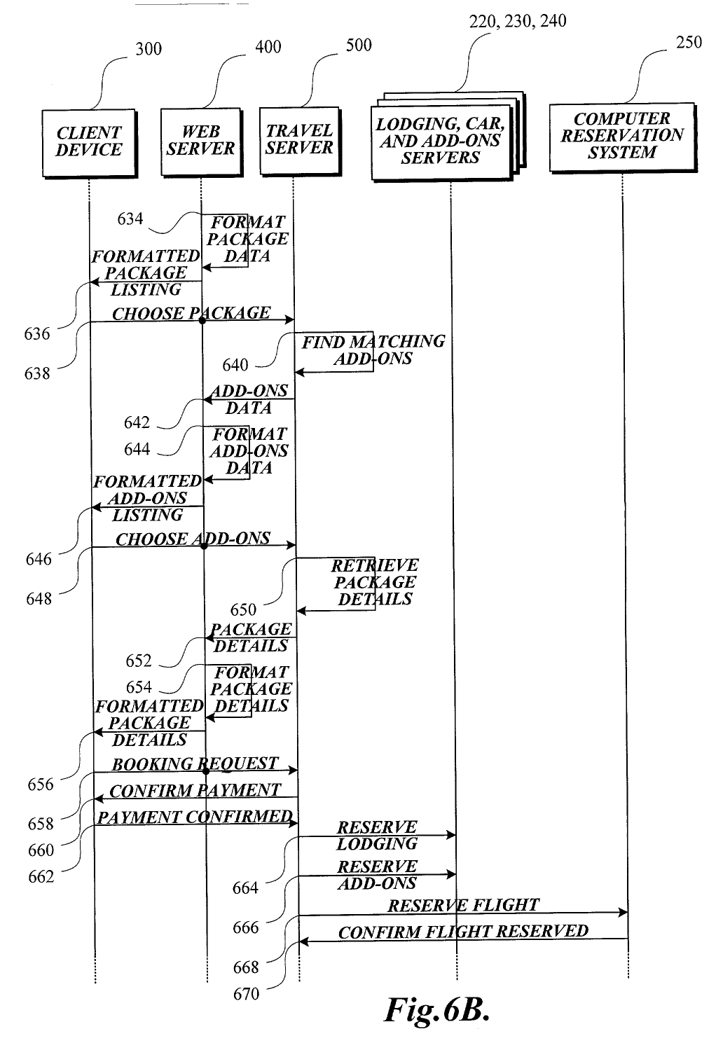

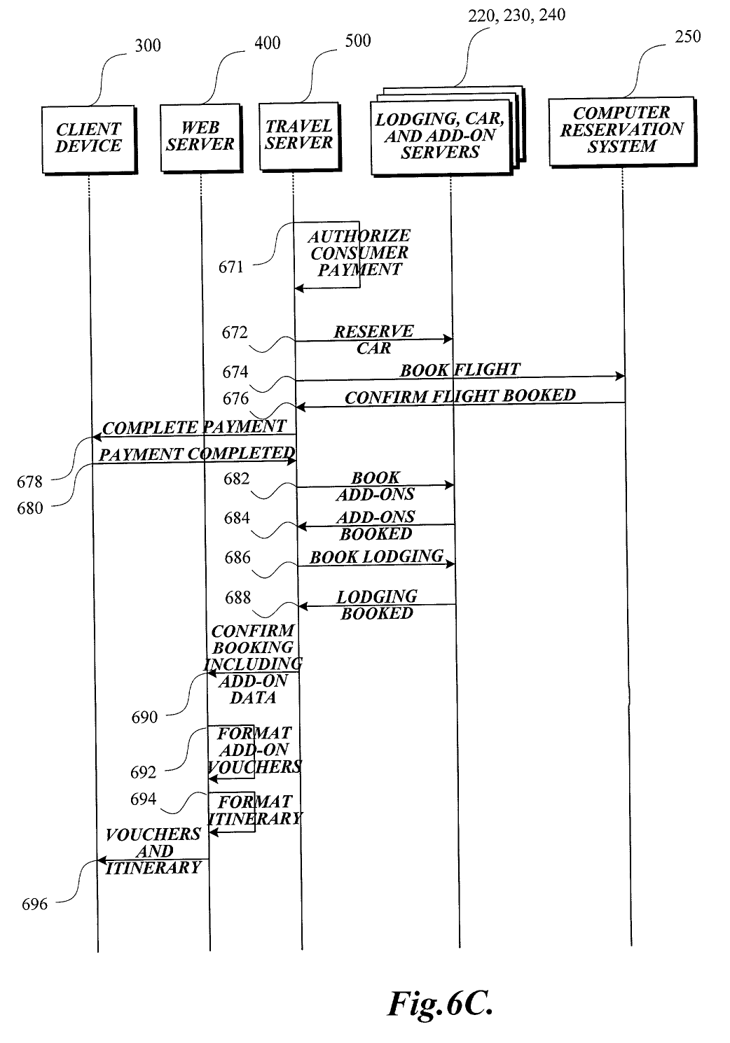

To better illustrate the operation of identifying and purchasing a travel package, FIGS. 6A-6C illustrate one embodiment of interactions between the devices of the travel package system 200 for identifying and purchasing travel packages. While air transportation is used below to describe an illustrative transportation component of the electronic travel packages of the present invention, those of ordinary skill in the art will appreciate that the present invention applies equally well to other forms of transportation, such as, but not limited to, train, bus, cruise, ferry or other forms of transportation. The devices of the system 200 illustrated in FIGS. 6A-6C include a client device 300, Web server 400, travel server 500, lodging, car and add-on servers 230, 240 and 220, respectively, and computer reservation system 250. The interactions of and the routines performed by the various devices are illustrated and described in greater detail with reference to FIGS. 7-11.

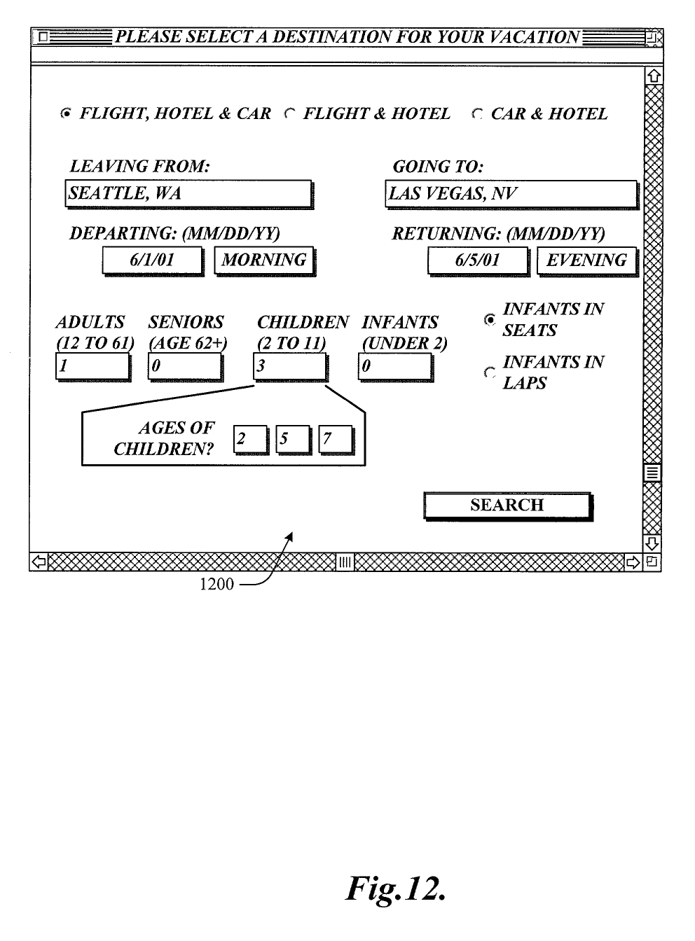

Returning to FIGS. 6A-6C, travel packages identification and purchasing is initiated when a client device 300 sends a package query 602 via the Web server 400 to the travel server 500 via a Web page (such as Web page 1200 illustrated in FIG. 12). Once the travel server receives the package query 602, it then queries 604 the lodging, car and add-on servers 230, 240 and 220, respectively, and sends out a flight availability query 606 to the computer reservation system 250. After which, and in no particular order, the computer reservation system returns real-time flight availability data 608, the lodging server 230 returns real-time lodging data 610, the cars server 240 returns real-time cars data 612, and the add-on server 220 returns real-time add-ons data 614. Once the travel server 500 has received the responses, it is then able to create a list of packages by first determining a best travel component, which in some cases may not be the lowest cost flight (as described below with regard to FIG. 11). In some cases the best package component may be a particular hotel or add-on which the consumer wishes to be part of a package, or even a room in a hotel that must have a particular view. It will be appreciated by those of ordinary skill in the art that a best package component may be determined from many similar criteria as those listed above. Once a best travel component has been determined it is then possible to find 618 other package components (e.g., lodging and car to match a flight component) that match the best package component thereby create a list of packages. Of course it will be appreciated by those of ordinary skill in the art that any type of “best” package components may be used to determine a package. Accordingly, a hotel might be the “best” component and the plurality of packages would have multiple flights matching the hotel stay. The same might be said for rental cars or even add-ons, in particular with regard to scheduled add-ons such as concerts, conventions or sporting events.

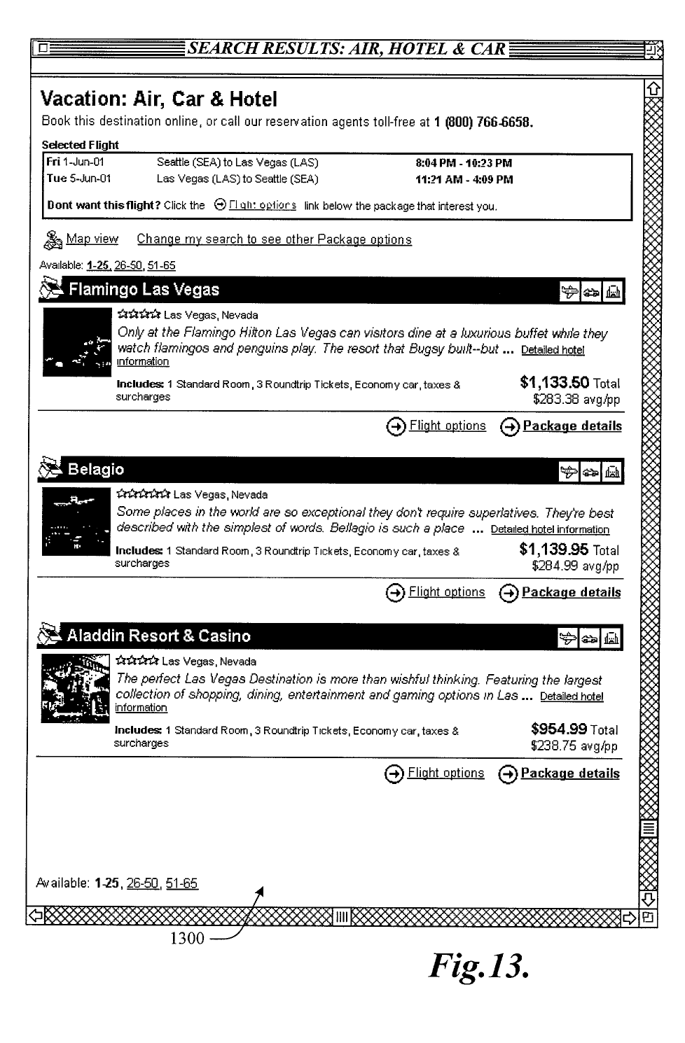

The travel server 500 then determines 620 if any package has tied add-ons that match the components of the package. The listing of packages containing the best component is sent as package data to the Web server 622, which then formats the package data 624 into a formatted package listing, and sends 626 the formatted package listing to the client device 300 via the Web page (such as Web page 133 illustrated in FIG. 13). Note that so far the consumer has only used two Web pages to get real-time pricing of travel packages. The first page was for entering package specification as a package query sent as shown as reference number 602. The other Web page is to receive the results of the query, shown as reference number 626. This provides an immediate basis for the consumer to make an informed choice of travel package.

If the consumer so desires, once they have the package listing, the client device 300 may then send a change of flight request 628 via the Web server 400 back to the travel server 500. The travel server 500 then matches new flights with lodging cars and any tied add-ons 630. The package data is again sent 632 back to the Web server 400 where it is again formatted 634 into a list of packages that is sent 636 to the client device as shown in FIG. 6B. The consumer may then choose a package 638 and the chosen package is sent back via the Web server 400 to the travel server 500. Next, the travel server 500 determines any matching add-ons 640 which were not tied to the original package. These matching add-ons are sent 642 to the Web server 400, which then formats 644 the add-ons data into a formatted add-ons listing, which in turn is forwarded 646 to the client device 300. Again, the consumer using the client device 300 is able to choose any desired add-ons 648. These chosen add-ons are sent via the Web server 400 to the travel server 500, thus completing the identification phase of the current invention. Note that only two Web pages would be used from the package query 602 to the package listing 626 to get real-time prices for available packages.

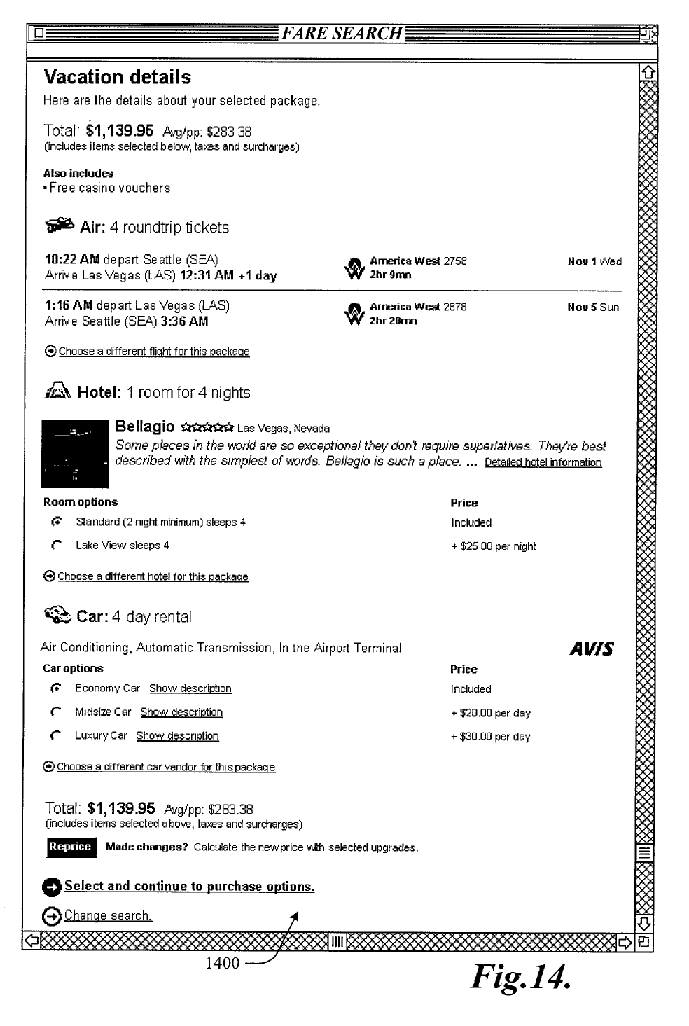

Once the identification phase of the current invention is completed, the purchase phase begins. More specifically referring in FIG. 6B after add-ons have been chosen, the travel server retrieves 650 package details and sends 652 the details to the Web server 400 where the Web server 400 then formats 654 the package details, and sends 656 these formatted package details to the client device 300 via a Web page (such as Web page 1400; illustrated in FIG. 14). Assuming the consumer wants to purchase the package, the client device 300 sends back 658 a booking request via the Web server 400 to the travel server 500. The travel server 500 then confirms payment 660 with the client device 300, possibly directly or through the Web server 400. The payment confirmation is returned 662 again via the Web server or possibly directly to the travel server 500. The travel server 500 then proceeds with the booking process in which the lodgings are reserved 664 at the lodging server 230, add-ons are reserved 666 with the add-on server 220. Then, the flight reservation 668 is sent to the computer reservation system 250 and a flight reservation confirmation is returned 670 to the travel server 500. The travel server 500 then authorizes the consumer payment 671, and once authorized, requests a car reservation 672 from the car server 240 as shown in FIG. 6C. Next the flight is booked 674 from the travel server 500 to the computer reservation system 250, which returns a booking confirmation 676 to the travel server 500. The payment process proceeds with the consumer by sending a completed payment request 678 from the travel server 500 to the client device 300, possibly via the Web server 400. The payment process is completed 680 from the client device 300, again, possibly via the Web server 400 to the travel server 500.

Once the payment process has been completed, then the add-ons are booked 682 from the travel server 500 to the add-on server 220, which confirms the add-ons booking 684 to the travel server 500. In turn, the lodgings are booked 686 from the travel server 500 to the lodging server 230 which returns a lodging confirmation 688 to the travel server 500. Once all the booking confirmations have been received, the travel server 500 sends the booking confirmations and add-on data 690 to the Web server 400. The Web server 400 takes the add-on data, formats add-on vouchers 692, and takes the booking confirmation and formats an itinerary 694. The vouchers and the itinerary are then sent 696 from the Web server 400 to the client device 300, thus completing the identification through the purchasing process of the present invention.

Note that the total number of Web pages that would be used from package query 602 to receiving vouchers and itinerary would only be seven (i.e., Web pages used with reference numbers 602, 626 and 638, 646 and 648, 656 and 658, 660 and 662, 678 and 680, and 696). If no optional add-ons were selected then even the 646 and 648 Web page could be eliminated. Similarly, if the booking request 658 were combined with the payment confirmation of 662 then another page would be eliminated. As one of ordinary skill in the art will appreciate, this is significantly fewer Web pages than is used by prior art systems for identifying and/or booking travel packages which typically require over 10 pages.

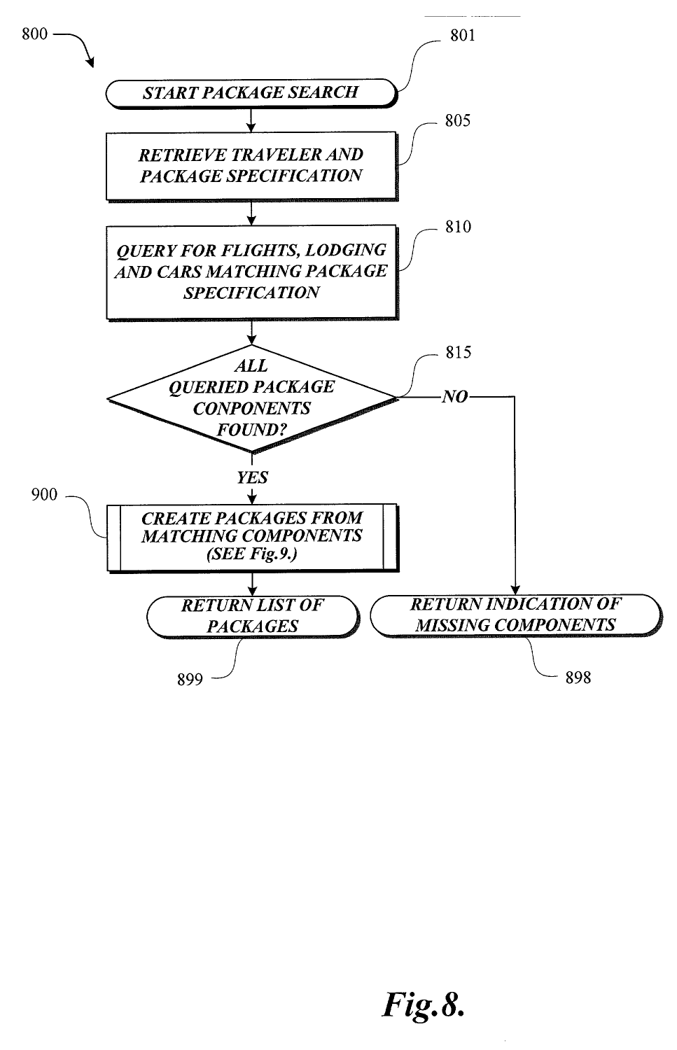

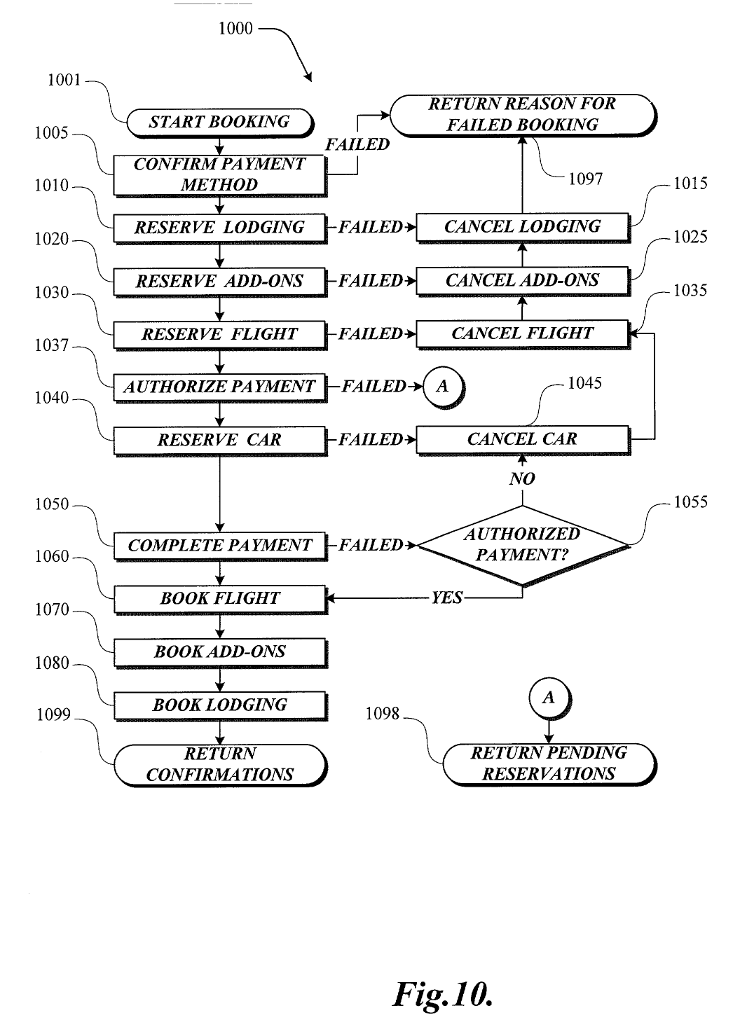

As illustrated in FIGS. 2, 5, and 6A-6C, the travel package system 200 of the present invention includes a travel server 500 that is used to identify and purchase travel packages requested by a client device 300. A flow chart illustrating a package service routine 700 implemented by the travel server 500, in accordance with one embodiment of the present invention, is shown in FIG. 7. The package service routine 700 begins in block 701 and proceeds to block 705, where a package query is received. The query could come from any number of sources such as third party travel servers or carriers but for exemplary purposes to illustrate one embodiment of the present invention the package query is forwarded from a consumer using a client device 300. The information in the package query is used next in subroutine block 800 (described in more detail below with regard to FIG. 8) to search for package components that may be combined into a list of packages that match the package query. Once subroutine 800 returns with a list of packages, the list of packages is forwarded to the consumer in block 710. In one embodiment the list of packages is in the form of package data sent to a Web server for further formatting and then for delivery to the consumer. If in the following decision block 715 it is determined that the entity querying for packages wishes to make changes, in this case the consumer, then in block 720 specific changes to the components desired in the list of packages will create a new listing of updated packages. As combinations of components have been cached from the package search retrieved in subroutine 800, it will usually not be necessary to search for new packages again. Accordingly, the logic returns to block 710. If however in decision block 715 it is determined that no changes to the package components are desired, then in block 725 a package selection is received from the consumer, in one embodiment possibly forwarded via the Web server 400. Next, in block 730, any matching add-ons to the selected package of block 725 are found and transmitted back to the consumer or other entity querying the travel server. Then, in block 735, if any add-ons have been selected they are received and added to the package previously selected in block 725. In block 740, package details for the selected package and any selected add-ons are retrieved and sent out for approval to the consumer or other querying party. Assuming that all is satisfactory with the package details in block 745 a booking request is received and the logic continues to subroutine 1000 (illustrated in greater detail with regard to FIG. 10 below) where the package is booked. Next, in block 750, the completed booking is confirmed either to the Web server 400 or directly with the querying consumer or other party. Assuming also that at least one add-on has been added to the package, then voucher information is also sent to the consumer in block 755. (The voucher creation routine is described below with regard to FIG. 11). In one embodiment the voucher information is sent to the Web server 400 for further formatting and processing before being sent on as a graphical image to the consumer or their client device 300. Routine 700 then ends in block 799.

In an alternate embodiment, routine 700 may be initiated with a querying entity requesting only one component of a package. In one exemplary case, the component is a flight component of a package. However, it will be appreciated by those of ordinary skill in the art that the package service routine may be initiated with any other travel component, e.g., car rental, lodging, cruise, etc., without departing from the spirit and scope of the present invention. An embodiment initiating a flight query is illustrated starting in block 702 of routine 700 which proceeds to block 760 where a flight search request is received along with a “cross-sell” option to proceed with a travel package instead of a single component. The option to proceed with a package request may then be chosen by the consumer. If in decision block 765 the consumer is determined to have chosen to proceed with a package search, the flight search query is used in subroutine 800 and the logic of routine 700 proceeds as described above. If, however, at decision block 765 no decision has been made to search for a package, logic continues to block 770 where a search is made for a flight. It will be appreciated by those of ordinary skill in the art that a myriad of flight search routines may be used at this point. One such flight search routine is the OPTIMIZED SYSTEM AND METHOD FOR FINDING BEST FARES, U.S. patent application Ser. No. 09/825,451, to Arthur Champernowne, filed on Apr. 4, 2001, that is herein incorporated by reference. After the flight search in block 770, the search results are transmitted to the requester in block 775 along with another cross-sell option. The cross-sell option may also include an abbreviated listing of real-time to help the consumer decide to produce a package. The requestor may then choose to proceed with a package and if decision block 780 it is determined that the requester wishes to proceed with a package then in decision block 785 it is further determined whether a specific hotel has been requested or designated by the requestor. If a specific hotel has not been requested, then the package search subroutine 800 is once again used to determine package components including hotels. If, however, in decision block 785, it is determined that a specific hotel has been designated then the package data of the flight and hotel is transmitted in block 710 and the logic continues as described above. If, however, back in decision block 780 it is determined that no package is desired, then the logic of routine 780 continues with a flight only booking 790 according to one of the many possible flight booking procedures known to those of ordinary skill in the art, and routine 700 then ends with respect to this embodiment in block 799.

The package search subroutine 800, introduced above, is illustrated in FIG. 8. The package search subroutine 800 is called each time the package service 700 needs to gather a new set of available components with real-time prices based on a new package query or a change in the details of a package query exceeding already cached package components. For example, if the destination dates or number of people or even the ages of the people in a travel party of a particular package are changed then the real-time prices, availability, and/or eligible components for packages will need to be modified and a new execution of the package search subroutine 800 may need to be processed.

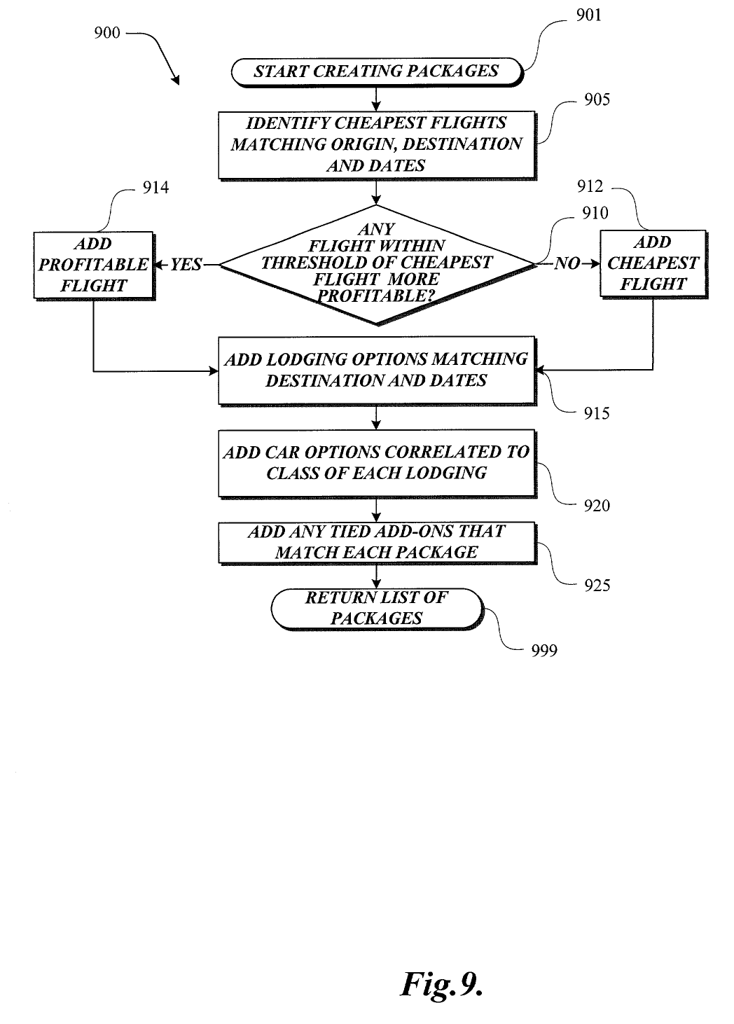

The subroutine 800 starts in block 801 and proceeds to block 805 where the traveler and package specifications which describe the criteria (each as the date, time, travelers, etc.) for creating a package are retrieved. The specifications are provided by the calling routine and in one embodiment are included in the package query received by the package service routine 700. Next, in block 810 queries are sent out for flights, lodging and cars matching traveler and package specifications. In one embodiment, the flight, lodging and car queries are to local databases residing on the travel server. In another embodiment, one or more of the flight, lodging and cars queries may be sent to remote servers particularly suited to handle such queries, such as the CRS 250, the cars server 240 and the lodging server 230. Next, in decision block 815, a determination is made whether all queried package components were found. If one or more components are found to be missing in decision block 815, then the logic of subroutine 800 returns to the calling routine with an indication of missing components in block 898. Otherwise, if in decision block 815 it was determined that real-time prices and availability for all components were found for at least one package, then the logic continues to the package creation subroutine 900 (described in greater detail with reference to FIG. 9 below) and upon returning from subroutine 900 with a list of packages, subroutine 800 ends in block 899 and returns the list of packages to the calling routine.

The package creation subroutine 900 is depicted in FIG. 9 and starts in block 901 and proceeds to block 905 where the cheapest flight component matching the origin, destination, and dates of the traveler and package specification are identified. As noted above, other package components may be used instead of flights when creating a package. However, for exemplary purposes, a flight component is used below. Next, in decision block 910, a determination is made whether any flights are within a threshold of the cheapest flight, but are more profitable. More specifically, it is possible that a number of different types of fares may be available for the same flight. One type of fare may be a published fare or “agency fare” (e.g., a published fare from a carrier) that is generally available for the flight. Another type of fare may be a merchant fare (e.g., a fare provided by a merchant at a mark-up from a wholesale price from a carrier), which may have a different price for the flight and different eligibility criteria. When comparing two fares, where one fare is a published fare and there is no merchant fare available for the flight, then the cheapest published fare would always be used. However, if a merchant fare is available, then a number of guiding principles come into play. In one exemplary embodiment, these principles may be that merchant fares should not be sold for more than published fares, and that all things being essentially equal, sell the published fare or the merchant fare depending on which one is more profitable. Also, when selling the merchant fare, it should be sold for at least as much as can be made on the published fare or to a maximum markup value, whichever is greater. To fulfill these principles as is being determined in decision block 910, the decisioning process proceeds essentially as follows. If a published or a merchant fare is the only one available, use the available one. If a published and a merchant fare are both available, then the following is done: Calculate the maximum potential markup that can be charged on the merchant fare without pricing it above the published fare, including taxes and service fees. Then calculate the margins for both published and merchant fares based on the carrier and whether or not the flight is domestic or international. If there is no way to make more of a margin on the merchant fare than on the published fare without pricing over the merchant fare then the published fare is chosen. Otherwise, the price that is charged for the merchant fare needs to be calculated. The potential margin may be adjusted to assure that it is at least as great as the margin of the published fare or is the maximum margin allowed by the carrier. In one exemplary embodiment, the margin may also be adjusted so that once the minimum margin for a carrier has been achieved, the difference between the allowable margin and the minimum will be split between the consumer and as profits on a rated basis in a predetermined manner. Once the margin has been adjusted the final selling price for the merchant flight fare can be calculated.

Returning to routine 900, in decision block 910 the decision as described above is made. If in decision block 910 there is found to be a more profitable flight within a threshold, then in block 914 the profitable flight is added to a package and processing continues in block 915. If, however, in decision block 910 there were no flights within a threshold of the cheapest flight that were more profitable or that met the more detailed criteria described above, then the cheapest flight is added to the package in block 912. Processing again continues in block 915 where lodging options matching the destination and dates and optionally the flight already added to the package are added as distinguishing components for each package thereby forming at least one package with a flight component and a hotel component or possibly many packages with identical flight components but distinguishing lodging components. Next, in block 920, the car options are correlated for each of the packages formed in block 915 to match the class of each lodging used in the packages. For example, in a five-star hotel package, instead of creating a package with car options that include an economy car, a luxury car might be included. While at a two-star hotel, it would be unlikely that a luxury car would be desirable for that package, and so an economy car might be included in a package with a two-star hotel. Similarly, the lodging query may have been correlated to the flight component as well. Next, in block 925, any add-ons that are tied to any of the components in these packages are added to the package. For example, if the lodging component includes a hotel that also has a casino, it would be possible to include complimentary gambling chips as a tied add-on that is included as part of the package. Similarly when renting a luxury car, there may be a complimentary upgrade with the car rental company if somebody is traveling on a particular date. Other types of add-ons will be discussed in much greater detail below with regard to the voucher creation routine in FIG. 11. Once any tied add-ons have been added, subroutine 900 returns to its calling routine at block 999 and returns a list of packages created.

As described earlier in FIG. 7 with regard to the package service routine 700, once a package has been selected and details of it transmitted to the requesting entity, the booking portion of the package service is handled by the booking subroutine 1000 shown in FIG. 10. The booking subroutine starts at block 1001 and proceeds to block 1005 where the payment method is confirmed with the consumer. If the payment method fails to be confirmed in block 1005, subroutine 1000 ends at block 1097 returning a failed booking notice, along with the reason for the failure. Once the payment method has been confirmed, logic continues to block 1010 where lodgings are reserved. If in block 1010 the lodging reservation fails, then logic continues in block 1015 where the lodging is canceled and then proceeds to block 1097 where the reason for the failed booking is returned to the calling routine. For example, if a hotel's last room was booked between the real-time pricing of the package and the reservation, a failure would result. If, however, lodging is successfully reserved in 1010, then in block 1020 any add-ons are reserved. If the add-ons fail to be reserved, then logic proceeds to 1025 and continues up, as before, including a returned reason for failure. In one case, if the last ticket to a show was sold before the reservation, it too would fail.

Once add-ons have been reserved in 1020, then in 1030 a flight is reserved. Similarly, if a flight reservation fails, then the logic proceeds to block 1035 where the flight is canceled and the rest of the cancellation blocks continue up canceling previous reservations as discussed earlier. As described above, if a flight's last seat was reserved/booked before the flight reservation, then the flight reservation too might fail.

If, however, in 1030 a flight was reserved, then in block 1037 a payment authorization is processed, which if it fails causes subroutine 1000 to return in block 1098 with pending reservations and no bookings, but does not cause the reservations to be canceled. This allows for intervention by customer service personnel or by different routines to further process the payment or an alternate payment so that the booking process can continue while still preserving the selected package and preserving it through the use of reservations. Assuming the authorization of payment in block 1037 does not fail, then in block 1040 a car is reserved. If, however, the car reservation fails, then the cancellation process starts at block 1045 and continues back through canceling all the earlier reservations.

Once a car reservation is complete in 1040, then in block 1050 payment for the package is completed. If payment fails then in decision block 1055 a determination is made whether the payment should be authorized. In some circumstances, such as when a traveler simply exceeds their credit limit, it may be worthwhile to authorize payment. In any case, if the payment is not authorized, then the logic continues up to block 1045 where the cancellation of previous reservations proceeds.

Otherwise, if in decision block 1055 payment is authorized or if in block 1050 payment was completed, then in block 1060 the flight is booked. After booking the flight in block 1060, any add-ons selected for the package are booked in block 1070 and in block 1080 lodgings are booked. Once all the bookings are complete, then in block 1099 booking confirmations are returned to the calling routine and subroutine 1000 ends.

One particular aspect to note of subroutine 1000, is that it is orchestrated to optimize a number of desirable features in an effective booking routine. In the booking process there may be different merchants involved in selling various components of the travel package. For example, the flight may be provided by a carrier through a centralized computer reservation system 250, hotels may have a similar reservation system, or server 230 may have presold spaces to another merchant or may have designated a merchant to be the seller of those rooms in place of the hotel. It is, therefore, beneficial to bring the package into a reserved state wherein the availability of the various components has been assured. Accordingly, in one embodiment in the present invention shown in FIG. 10, the components are first reserved and then once all the reservations have been confirmed, then and only then, does the booking process proceed.

It will also be apparent to one of ordinary skill in the art that not all components of a package need to be booked. For example, it is common to not book a car, rather to simply reserve a car and a car of the reserved class or better will be provided at the reserved price once a traveler reaches the car rental agency. Payment may have been noted in the car reservation or the consumer could also be provided a voucher to provide to the car rental company to indicate that they have already paid for the reserved car. Therefore, by first making reservations to assure the availability of components in a package and then following the reservations with the booking process, the present invention assures the orderly purchase and booking of components of packages across multiple merchants and also provides for an orderly cancellation process of reservations should any one component fail to be available at booking time for a particular package.

As discussed earlier with regard to add-ons and potentially with other components of travel packages such as car rentals, the consumer may be provided vouchers to indicate that they have already paid for one or more components of a travel package. FIG. 11 illustrates the voucher creation routine 1100. Routine 1100 starts at block 1101 and proceeds to block 1110 where voucher data is received from the travel server 500 (see block 755 of FIG. 7). Next, in block 1120 a graphical image of each voucher is generated incorporating the voucher information within the graphical image. Then in block 1130, the vouchers are transmitted to the consumer's client device 300. Finally, in block 1199, routine 1100 ends.

Vouchers can take many forms, but traditionally package sellers have sent hard copy vouchers via the postal service to recipients. The present invention avoids dealing with mail delays or mail that does not arrive and provides the consumer with easily accessible vouchers that can be kept together with the package details provided by the package service 700. One exemplary voucher used in one embodiment of the present invention includes a voucher serial number, traveler names, attraction or service identifiers, title redemption instructions, valid dates of use, itinerary number, vendor name, address, phone number, and an anti-fraud security code. Such an anti-fraud security code would include use-dependent information such as the traveler's name, valid dates of use, the attraction or service identifier, and would be correlated with the voucher serial number to allow for fraud checking. The vouchers may also include static elements such as a provider logo, customer service number, terms and conditions, and titles for various elements. All the elements would be combined into a voucher layout and then rendered as a graphical image.

One additional benefit of graphical images is that, as those of ordinary skill in the art will appreciate, most conventional Web browsers such as the Web browser 360 of the client device 300 will place a page break before an image such that it will not be printed across multiple pages when printing a Web page. By formatting the vouchers to be of a particular size, it is then possible to assure that vouchers will each probably be printed on an individual page, thereby making it much easier for both consumers and vendors receiving the vouchers to make sure that the correct voucher is used for the correct service and that no vouchers are accidentally damaged due to tearing or cutting to separate them.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for identifying a travel package, the method comprising:
retrieving a plurality of package components in response to a package query;
determining a best package component from said package components; and
depicting a plurality of packages with package components that match said best package component with a real-time price for each package.

2. The method of claim 1, wherein said package components include a lodging component.

3. The method of claim 2, wherein said package components further include a vehicle component.

4. The method of claim 2, wherein said package components further include a transportation component.

5. The method of claim 1, wherein said best package component comprises a transportation component.

6. The method of claim 1, wherein said best package component comprises a lodging component.

7. The method of claim 1, wherein said best package component comprises a vehicle component.

8. The method of claim 1, wherein said best package component comprises an add-on component.

9. The method of claim 1, wherein depicting a plurality of packages comprises depicting said plurality of packages within a hypertext interactive environment using only two hypertext pages.

10. The method of claim 1, further comprising booking a travel package, wherein depicting a plurality of travel packages and booking one of said plurality of travel packages and booking one of said plurality of travel packages within a noninteractive hypertext environment using fewer than seven hypertext pages.

11. The method of claim 1, wherein said real-time price includes a real-time price for a package component determined in relation to a corresponding published price for said package component.

12. The method of claim 11, wherein the relation between the real-time price at said package component and said published price for said package component is calculated to maximize said real-time price of said package component relative to said published price for said package component.

13. The method of claim 11, wherein said real-time price is calculated by increasing a merchant price to correspond to a predetermined percentage of said published price.

14. The method of claim 1, further comprising selecting a desired package from said plurality of packages within a hypertext interactive environment.

15. The method of claim 14, further comprising determining any add-ons that match said desired package.

16. The method of claim 15, further comprising selecting any desired add-ons to said desired package and adding said add-ons to said desired package.

17. The method of claim 16, further comprising delivering vouchers for any desired add-ons via the hypertext interactive environment.

18. The method of claim 17, wherein said voucher includes tamper-resistant elements.

19. The method of claim 18, wherein said tamper-resistant elements include a registered serial number for each voucher.

20. The method of claim 18, wherein said tamper resistant elements include a security code corresponding to a type of voucher and an authorized user.

21. The method of claim 17, wherein said voucher comprises a graphical image delivered in the hypertext interactive environment.

22. A method of finding a travel package corresponding to a component, the method comprising:
obtaining a component query;
responding to said component query by depicting real-time prices for a plurality of components along with an abbreviated listing of packages matching said component query.

23. The method of claim 22, wherein said component query is a flight query and said components are flight components.

24. The method of claim 22, wherein said component query is a lodging query and said components are lodging components.

25. The method of claim 22, wherein said component query is a vehicle query and said components are vehicle components.

26. The method of claim 22, wherein said component query is an add-on query and said components are add-on components.

27. A method for finding a travel package, the method comprising:
retrieving a plurality of types of package components in response to a package query;
depicting a plurality of packages with a first type of package components that correspond to each class of a second type of package components with real-time prices for each package.

28. The method of claim 27, further comprising selecting a desired package from said plurality of packages within a hypertext interactive environment.

29. A computer readable medium containing computer executable instructions for identifying a travel package, comprising:
retrieving a plurality of package components in response to a package query;
determining a best package component from said package components; and
depicting a plurality of packages with package components that match said best package component with a real-time price for each package.

30. The computer readable medium of claim 29, wherein said package components include a lodging component.

31. The computer readable medium of claim 30, wherein said package components further include a vehicle component.

32. The computer readable medium of claim 30, wherein said package components further include a transportation component.

33. The computer readable medium of claim 29, wherein said best package component comprises a transportation component.

34. The computer readable medium of claim 29, wherein said best package component comprises a lodging component.

35. The computer readable medium of claim 29, wherein said best package component comprises a vehicle component.

36. The computer readable medium of claim 29, wherein said best package component comprises an add-on component.

37. The computer readable medium of claim 29, wherein depicting a plurality of packages comprises depicting said plurality of packages within a hypertext interactive environment using only two hypertext pages.

38. The computer readable medium of claim 29, further comprising booking a travel package, wherein depicting a plurality of travel packages and booking one of said plurality of travel packages within noninteractive hypertext environment using fewer than seven hypertext pages.

39. The computer readable medium of claim 29, wherein said real-time price includes a real-time price for a package component determined in relation to a corresponding published price for said package component.

40. The computer readable medium of claim 39, wherein the relation between the real-time price at said package component and said published price for said package component is calculated to maximize said real-time price of each package component relative to said published package price for said package component.

41. The computer readable medium of claim 39, wherein said real-time price is calculated by increasing a discount price to correspond to a predetermined percentage of said published package price.

42. The computer readable medium of claim 29, further comprising selecting a desired package from said plurality of packages within a hypertext interactive environment.

43. The computer readable medium of claim 42, further comprising determining any add-ons that match said desired package.

44. The computer readable medium of claim 43, further comprising selecting any desired add-ons to said desired package and adding said add-ons to said desired package.

45. The computer readable medium of claim 44, further comprising delivering vouchers for any desired add-ons via the hypertext interactive environment.

46. The computer readable medium of claim 45, wherein said voucher includes tamper-resistant elements.

47. The computer readable medium of claim 46, wherein said tamper-resistant elements include a registered serial number for each voucher.

48. The computer readable medium of claim 46, wherein said tamper resistant elements include a security code corresponding to a type of voucher and an authorized user.

49. The computer readable medium of claim 30, wherein said voucher comprises a graphical image delivered in the hypertext interactive environment.

50. A computer readable medium containing computer executable instructions for finding a travel package corresponding to a component comprising:
obtaining a component query;
responding to said component query by depicting real-time prices for a plurality of components along with an abbreviated listing of packages matching said component query.

51. The method of claim 50, wherein said component query is a flight query and said components are flight components.

52. The method of claim 50, wherein said component query is a lodging query and said components are lodging components.

53. The method of claim 50, wherein said component query is a vehicle query and said components are vehicle components.

54. The method of claim 50, wherein said component query is an add-on query and said components are add-on components.

55. A computer readable medium containing computer executable instructions for finding a travel package comprising:
retrieving a plurality of types of package components in response to a package query;
depicting a plurality of packages with a first type of package components that correspond to each class of a second type of package components with real-time prices for each package.

56. The computer readable medium of claim 55, further comprising selecting a desired package from said plurality of packages within a hypertext interactive environment.

57. A computing apparatus for identifying a travel package, the computing apparatus operative to:
retrieve a plurality of package components in response to a package query;
determine a best package component from said package components; and
depict a plurality of packages with package components that match said best package component with a real-time price for each package.

58. The computing apparatus of claim 57, wherein said package components include a lodging component.

59. The computing apparatus of claim 58, wherein said package components further include a vehicle component.

60. The computing apparatus of claim 58, wherein said package components further include a transportation component.

61. The computing apparatus of claim 57, wherein said best package component comprises a transportation component.

62. The computing apparatus of claim 57, wherein said best package component comprises a lodging component.

63. The computing apparatus of claim 57, wherein said best package component comprises a vehicle component.

64. The computing apparatus of claim 57, wherein said best package component comprises an add-on component.

65. The computing apparatus of claim 57, wherein depicting a plurality of packages comprises depicting said plurality of packages within a hypertext interactive environment using only two hypertext pages.

66. The computing apparatus of claim 57, further comprising booking a travel package, wherein depicting a plurality of travel packages and booking one of said plurality of travel packages and booking one of said plurality of travel packages within a noninteractive hypertext environment using fewer than seven hypertext pages.

67. The computing apparatus of claim 57, wherein said real-time price includes a real-time price for a package component determined in relation to a corresponding published price for said package component.

68. The computing apparatus of claim 67, wherein the relation between the real-time price at said package component and said published price for said package component is calculated to maximize said real-time price of said package component relative to said published package price for said package component.

69. The computing apparatus of claim 67, wherein said real-time price is calculated by increasing a discount price to correspond to a predetermined percentage of said published package price.

70. The computing apparatus of claim 57, further comprising selecting a desired package from said plurality of packages within a hypertext interactive environment.

71. The computing apparatus of claim 70, further comprising determining any add-ons that match said desired package.

72. The computing apparatus of claim 71, further comprising selecting any desired add-ons to said desired package and adding said add-ons to said desired package.

73. The computing apparatus of claim 72, further comprising delivering vouchers for any desired add-ons via the hypertext interactive environment.

74. The computing apparatus of claim 73, wherein said voucher includes tamper-resistant elements.

75. The computing apparatus of claim 74, wherein said tamper-resistant elements include a registered serial number for each voucher.

76. The computing apparatus of claim 74, wherein said tamper resistant elements include a security code corresponding to a type of voucher and an authorized user.

77. The computing apparatus of claim 73, wherein said voucher comprises a graphical image delivered in the hypertext interactive environment.

78. A computing apparatus of finding a travel package corresponding to a component, the computing apparatus operative to:
obtaining a component query;
responding to said component query by depicting real-time prices for a plurality of components along with an abbreviated listing of packages matching said component query.

79. The computing apparatus of claim 78, wherein said component query is a flight query and said components are flight components.

80. The computing apparatus of claim 78, wherein said component query is a lodging query and said components are lodging components.

81. The computing apparatus of claim 78, wherein said component query is a vehicle query and said components are vehicle components.

82. The computing apparatus of claim 78, wherein said component query is an add-on query and said components are add-on components.

83. A computing apparatus for finding a travel package, the computing apparatus operative to:
retrieving a plurality of types of package components in response to a package query;
depicting a plurality of packages with a first type of package components that correspond to each class of a second type of package components with real-time prices for each package.

84. The computing apparatus of claim 83, further comprising selecting a desired package from said plurality of packages within a hypertext interactive environment.

85. A computing system for finding a travel package comprising:
a requesting device operative to:
transmit a travel package query via a Web server;
said travel server operative to:
retrieve a plurality of package components in response to a package query;
determining a best travel component from said package components; and
depict a plurality of packages to said consumer device with package components that match said best travel component with a real-time price for each package.

86. The system of claim 85, wherein said consumer device is further operative to select a desired package from said plurality of packages within a hypertext interactive environment and to forward said selection of said desired package to said travel server.

87 The system of claim 86, wherein said travel server is further operative to determine any add-ons that match said desired package and to forward a list of said add-ons to said consumer device.

88. The system of claim 87, wherein said consumer device is further operative to select any desired add-ons from said list of matching add-ons and forward said selection of any desired add-ons to said travel server; and
said travel server further operative to add said add-ons to said desired package.

89. The system of claim 88, wherein said travel server is further operative to forward voucher information for said desired add-ons to said Web server; and
said Web server is further operative to create a voucher from said voucher information and forward said voucher to said consumer device.

90. The system of claim 89, wherein said voucher includes tamper-resistant elements.

91. A computer readable medium containing computer executable routines comprising:
a package routine operative to:
retrieve a plurality of package components from a package search routine in response to a package query;
said package search routine operative to:
identify desired packages from said package query in cooperation with a package creation routine; and
said package creation routine operative to:
create packages having real-time prices and availability information.

92. The computer readable medium of claim 91, further comprising a booking routine operative to:
book one of said packages created by said package creation routine.

93. The computer readable medium of claim 93, wherein said booked package contains at least one add-on component, and said package routine is further operative to:
communicate voucher information for said at least one add-on to a voucher creation routine for creating at least one voucher for said at least one add-on.
